(19) United States
(12) Patent Application Publication
(10) Pub. No.: US 2016/0005028 A1
(43) Pub. Date: Jan. 7, 2016

(54) Systems and Methods for Providing Gifts Via a Mobile Messaging Platform

(71) Applicant: Verizon Patent and Licensing Inc., Arlington, VA (US)

(72) Inventors: Amir Mayblum, Walnut Creek, CA (US); Lodema M. Steinbach, Clayton, CA (US); Keith P. Lampron, Lebanon, NJ (US)

(21) Appl. No.: 14/324,307

(22) Filed: Jul. 7, 2014

(51) Int. Cl. G06Q 20/34; G06Q 20/32; G06Q 30/06

(52) U.S. Cl. CPC G06Q 20/342; G06Q 30/0635; G06Q 30/0603; G06Q 20/3255

(57) ABSTRACT

Systems and methods for creating gift messages for sending to individuals via an existing messaging infrastructure are described. A gift provider system may receive a request for a gift catalog from a first user device. The gift provider system may provide an interactive gift catalog to the first user device that includes one or more gift cards available for purchase. The user of the first user device may select the amount of the gift card, create a personalized message for the gift card, select a recipient, and select graphics that may accompany the gift card. The gift provider system may create a gift message based on the purchased gift card and send the gift message to the recipient. The gift message may be sent as an MMS message and may include one or more codes that the recipient can use to redeem the gift card with a providing merchant.

### BACKGROUND INFORMATION

Currently, many individuals use mobile devices to exchange text messages. The text messages may include pictures and videos that are attached by the user. By contrast, individuals that purchase gift cards for friends and family members must send them via email or paper mail. The recipient must then print out a gift card or write down a gift card number and physically present the print-out to a merchant for redemption and/or enter the number online. This is inefficient and inconvenient for users who increasingly communicate using text messaging on their mobile device platforms.

These and other drawbacks exist.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a schematic diagram of a hardware component of the system of a particular embodiment;

FIGS. 3A, 3B, 3C, 3D, 3E, and 3F depict screenshots of a particular embodiment.

FIGS. 4A, 4B, 4C, 4D, and 4E depict screenshots of a particular embodiment; and

FIG. 5 is a block diagram of a method of a particular embodiment.

### DETAILED DESCRIPTION OF PREFERRED EMBODIMENTS

A system and method described here may include various embodiments for providing gifts via a messaging platform. The gifts may be sent as gift messages. A mobile device may include a messaging interface that allows the user to attach a gift to a message that is sent to another user. The message may be sent as a multimedia messaging service (MMS) message. The messaging interface may display a catalog of gifts that are available for purchase by the user. The gifts may be available for purchase in the form of gift cards provided by various merchants that can later be redeemed with those merchants in exchange for merchandise. The catalog may be generated based on demographic information associated with the user, information associated with other users across similar demographics, and prior purchases. Using the interface, the user may select the gift card, the amount, the recipient, and create a personalized message for the recipient. The user may select various designs and graphics that can be incorporated with the gift message as a postcard.

The system may generate a gift card that is incorporated into a message from the user. The message may include the postcard. The message may include a barcode for the gift. The message may include a Personal Identification Number (PIN), a QR code, a redemption code, and/or a serial number. The message may be an MMS message. The message may be sent to the recipient's mobile device. The message may have one or more interactive features that allow the recipient to redeem the gift card electronically.

The description below describes interface modules, catalog modules, authentication modules, analytics modules, message conversion modules, merchant modules, charging modules, settlement modules, administrator modules, personal inventory modules, user devices, mobile gift providers, computer systems, and networks that may include one or more modules, some of which are explicitly shown while others are not. As used herein, the term “module” may be understood to refer to computing software, firmware, hardware, and/or various combinations thereof. It is noted that the modules are examples. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

It is further noted that software described herein may be tangibly embodied in one or more physical media, such as, but not limited to, a compact disc (“CD”), a digital versatile disc (“DVD”), a floppy disk, a hard drive, read only memory (“ROM”), random access memory (“RAM”), as well as other physical media capable of storing software, and/or combinations thereof. The functions described as being performed at various components may be performed at other components, and the various components may be combined and/or separated. Other modifications also may be made.

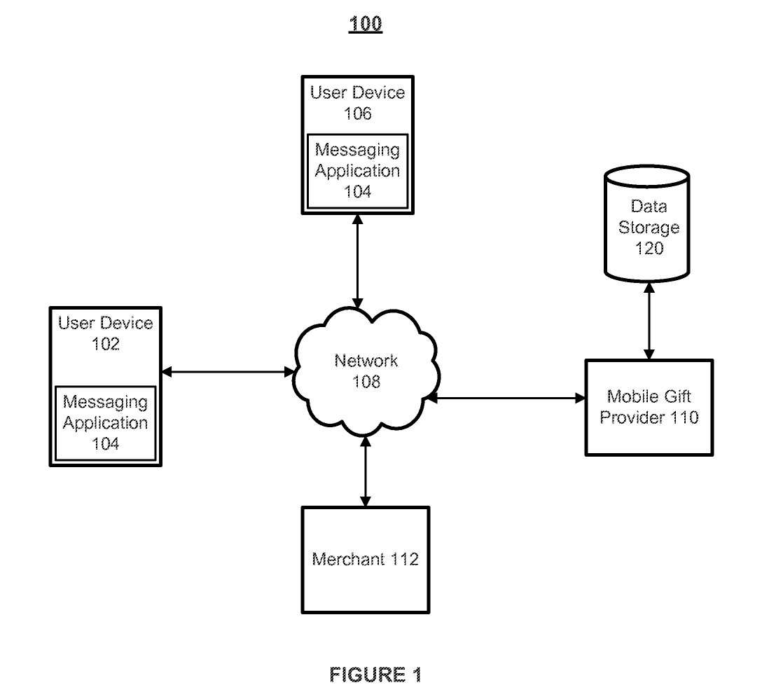

FIG. 1 is a schematic diagram illustrating a system according to a particular embodiment. A system 100 may include user device 102, a second user device 106, a network 108, mobile gift provider system 110, merchant 112, and data storage 120. Although elements of system 100 may be described as a single device, it will be appreciated that multiple instances of these devices may be included in system 100, such as, for example, multiple user devices, multiple merchants, multiple gift provider systems, multiple data storages, and multiple networks. A first user may be associated with user device 102. A second user may be associated with user device 106.

User devices 102 and 106 may be, for example, but not limited to, a cellular telephone, Session Initiation Protocol (“SIP”) phone, software client/phone, a desktop computer, a laptop/notebook, a server, a module, a satellite phone, a personal digital assistant (“PDA”), a tablet computer, a smart phone, a remote controller, a personal computer (“PC”), a workstation, a handheld PC, a handheld MP3 player, a handheld video player, a personal media player, a gaming device, a thin system, a fat system, a network appliance, and/or other mobile communication device that may be capable of transmitting and/or receiving data. Also, user devices 102 and 106 may include one or more transmitters, receivers, and/or transceivers to transmit and/or receive one or more signals to and/or from other components depicted in FIG. 1, including, for example, gift provider system 110.

Network 108 may be a wireless network, a wired network, or any combination of wireless network and wired network. For example, network 108 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, network 108 may include, without limitation, telephone line, fiber optics, IEEE Ethernet 802.3, a wide area network (“WAN”), a local area network (“LAN”), or a global network such as the Internet. Also, network 108 may support, an Internet network, a wireless communication network, a cellular network, or the like, or any combination thereof. Network 108 may be a 4G network that complies with the International Mobile Telecommunications Advanced (IMT-Advanced) specification. Network 108 may be a Long Term Evolution (LTE) network. Network 108 may be a LTE Advanced (LTE-A) network. Network 108 may be a Mobile WiMAX (IEEE 802.16e). Network 108 may be a Mobile WiMAX Release 2 (IEEE 802.16m) network. Network 108 may further include one, or any number of the exemplary types of networks mentioned above operating as a stand-alone network or in cooperation with each other. Network 108 may utilize one or more protocols of one or more network elements to which it is communicatively coupled. Network 108 may translate to or from other protocols to one or more protocols of network devices. Although network 108 is depicted as one network, it should be appreciated that according to one or more embodiments, network 108 may comprise a plurality of interconnected networks, such as, for example, a service provider network, the Internet, a broadcaster's network, a cable television network, corporate networks, and home networks.

The components depicted in FIG. 1 may transmit and receive data to and from network 108 representing broadcast content, user request content, parallel search queries, parallel search responses, and other data. The data may be transmitted and received utilizing a standard telecommunications protocol or a standard networking protocol. For example, one embodiment may utilize Session Initiation Protocol (“SIP”). In other embodiments, the data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 108 may use standard wireless protocols including IEEE 802.11a, 802.11b and 802.11g. Network 108 may also use protocols for a wired connection, such as an IEEE Ethernet 802.3.

Data storage 120 may be network accessible storage and may be local, remote, or a combination thereof to the components depicted in FIG. 1. Data storage 120 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage 120 may be a database, such as an Oracle database, a Microsoft SQL Server database, a DB2 database, a MySQL database, a Sybase database, an object oriented database, a hierarchical database, or other database. Data storage 120 may utilize flat file structures for storage of data. Data storage 120 may be communicatively coupled to gridsearch system 110, or to any other component depicted in FIG. 1. Any of the other components depicted in FIG. 1 may include one or more data storages as well.

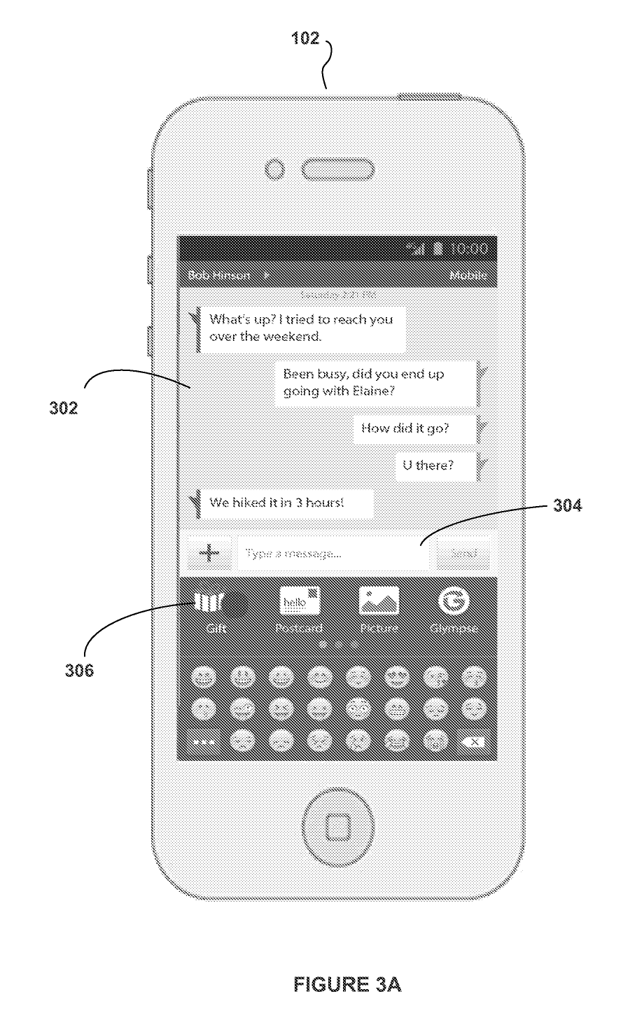

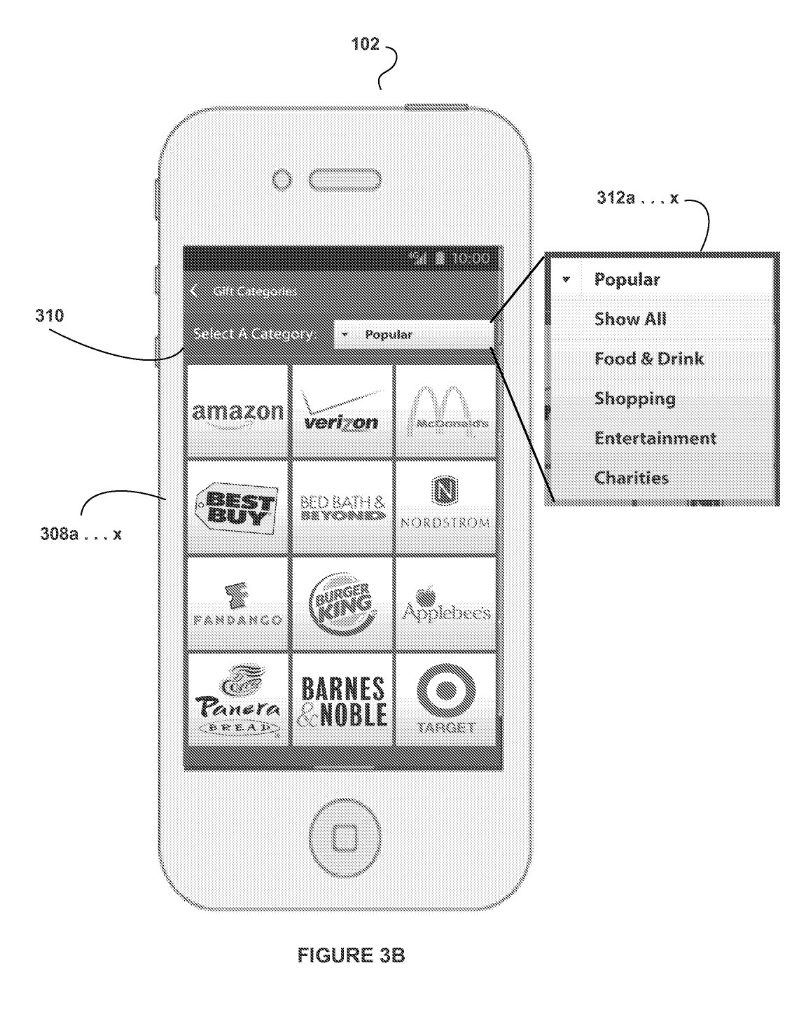

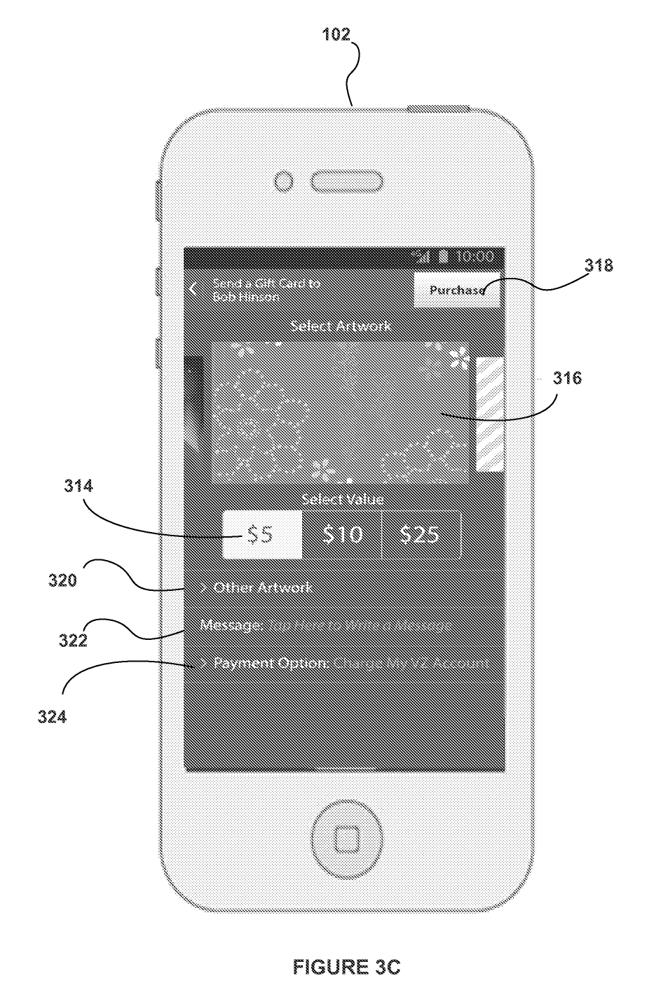

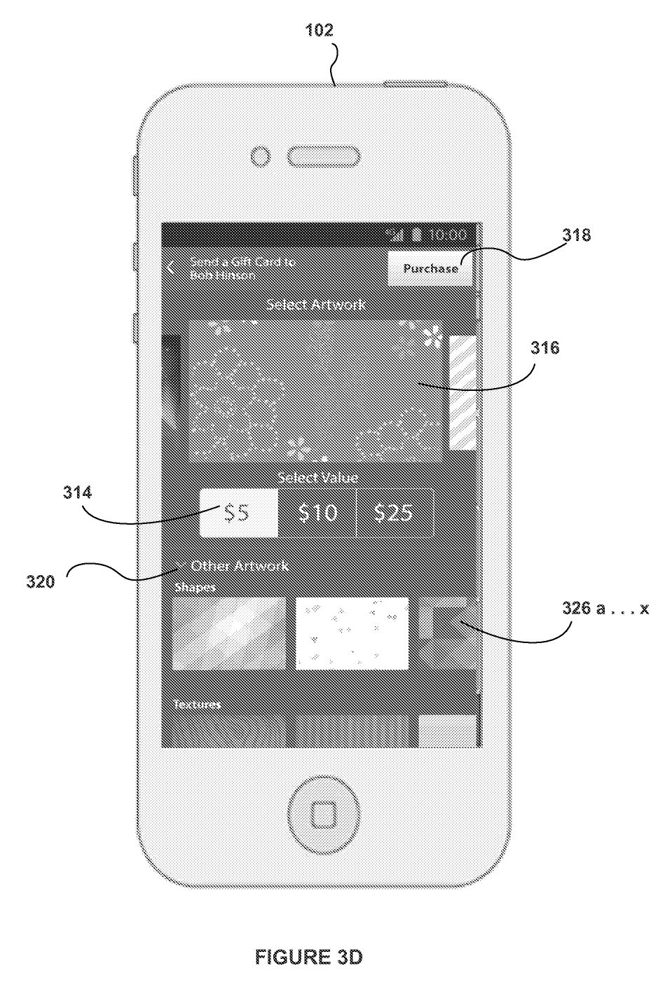

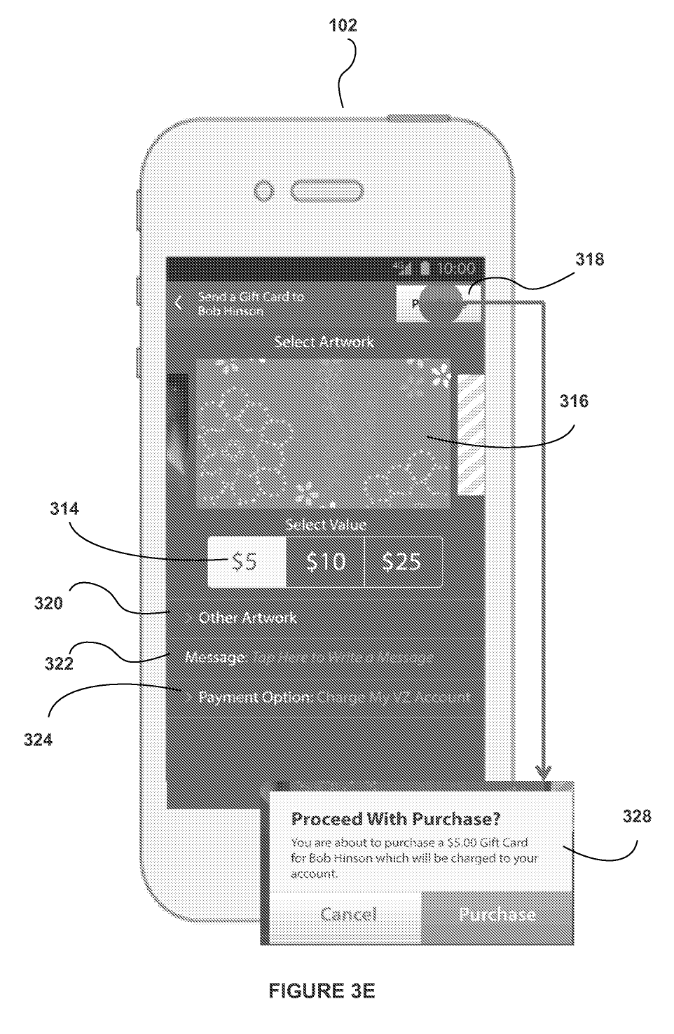

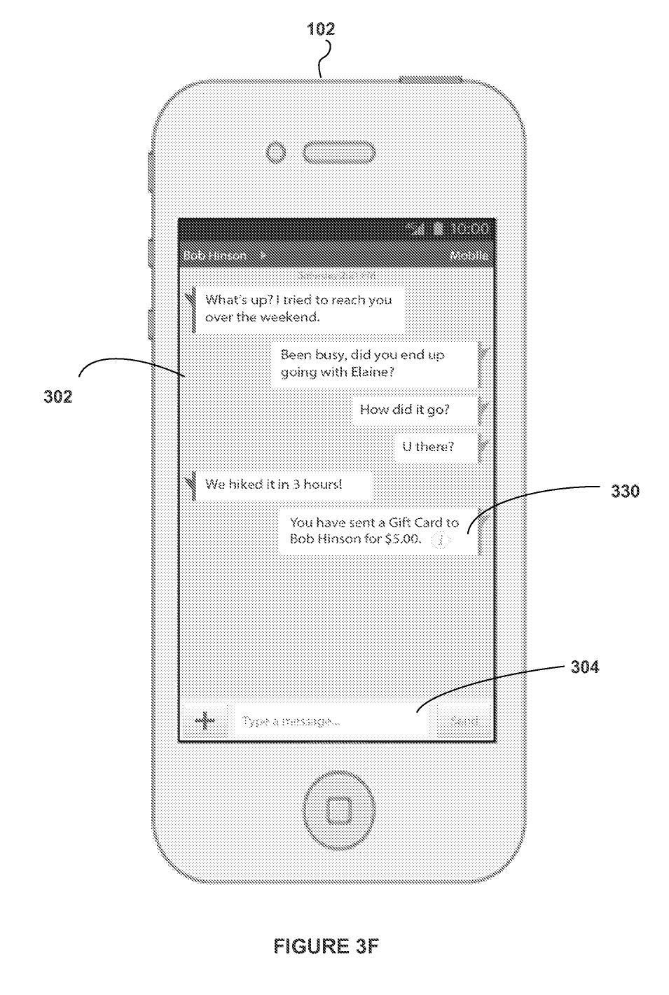

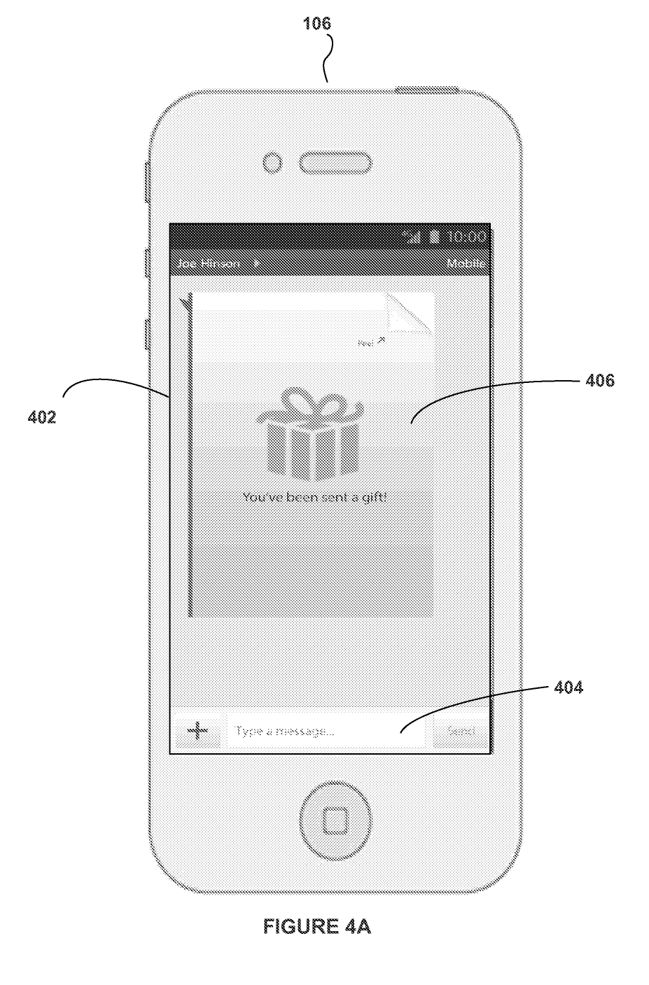

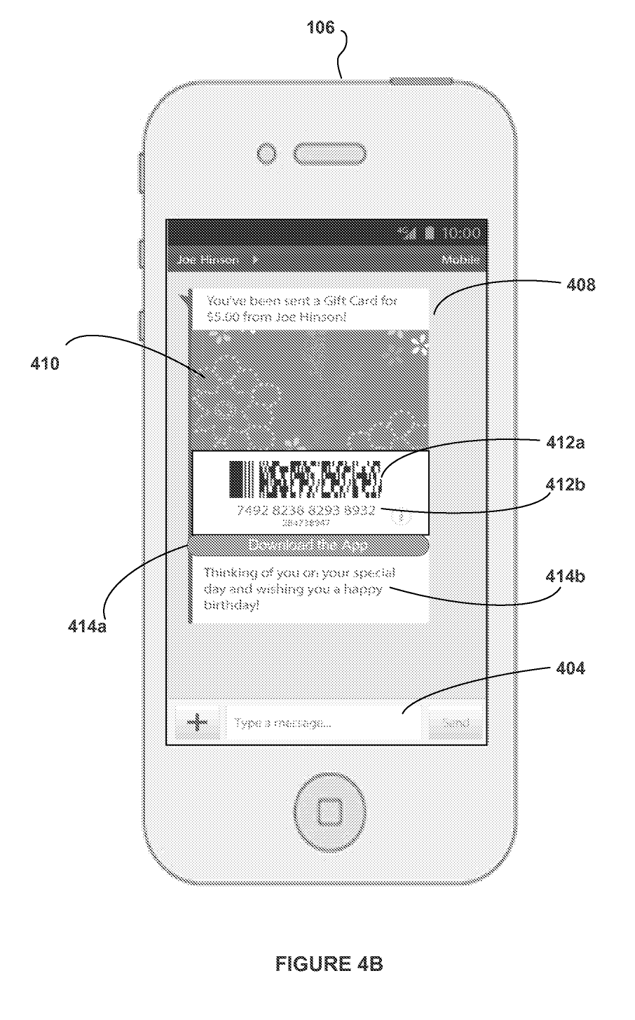

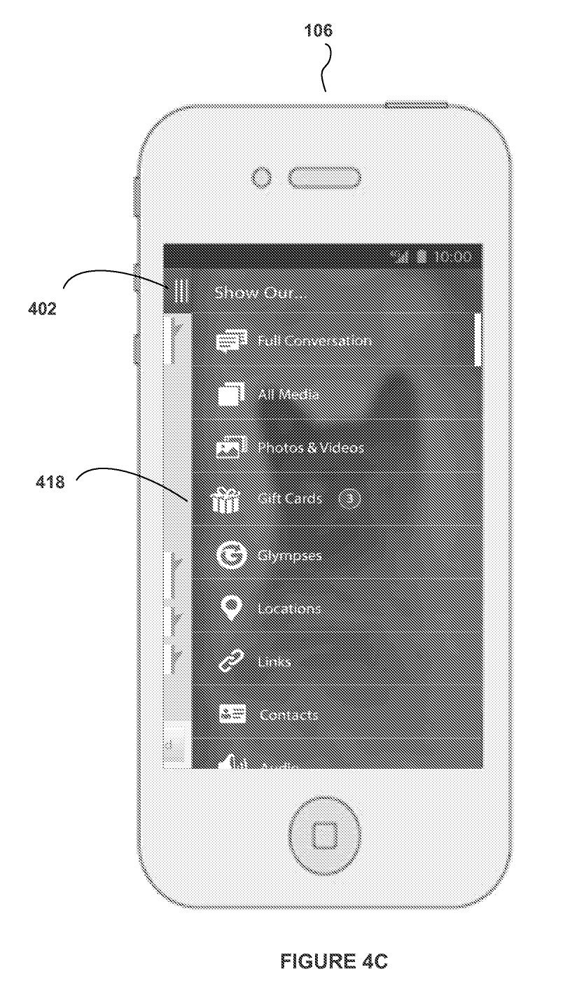

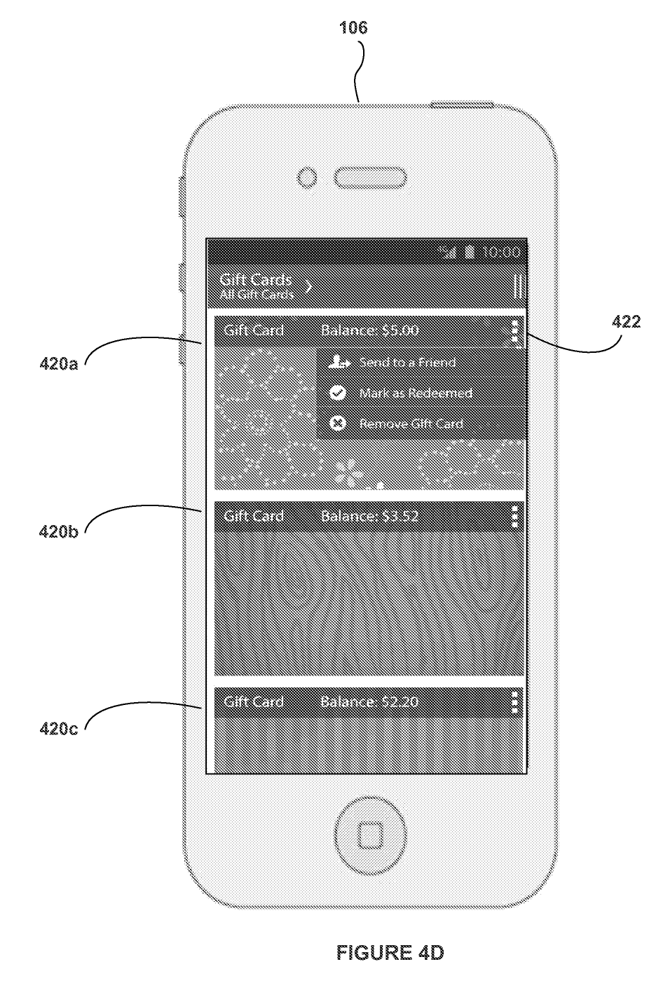

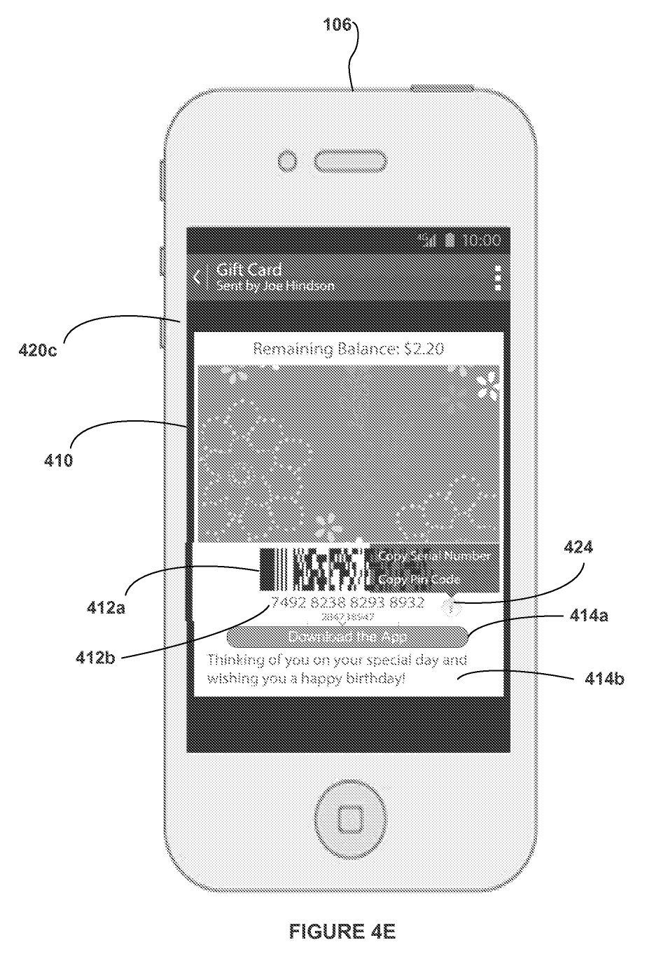

User device 102 and/or user device 106 may include messaging application 104. Messaging application 104 may be a combination of software and hardware configured to provide an interface for user devices 102 and 106 to exchange messages. The messages may be text messages. The messages may be MMS messages. The messages may be SMS messages. Embodiments of the interface of messaging application 104 are shown in FIGS. 3A, 3F, 4A, and 4B. In FIG. 3A, messaging application 104 may present a messaging interface 302 on user device 102. The messaging interface 302 shows messages between user device 102 and another user device, such as user device 106. The messaging interface 302 may include a text box 304 where the user can type a message (using, for example, a keypad generated by messaging interface 302). In the embodiment in FIG. 3A, messages from user device 102 are shown on the right side of interface 302, and messages from user device 106 (“Bob Hinson”) are shown on the left side of interface 302.

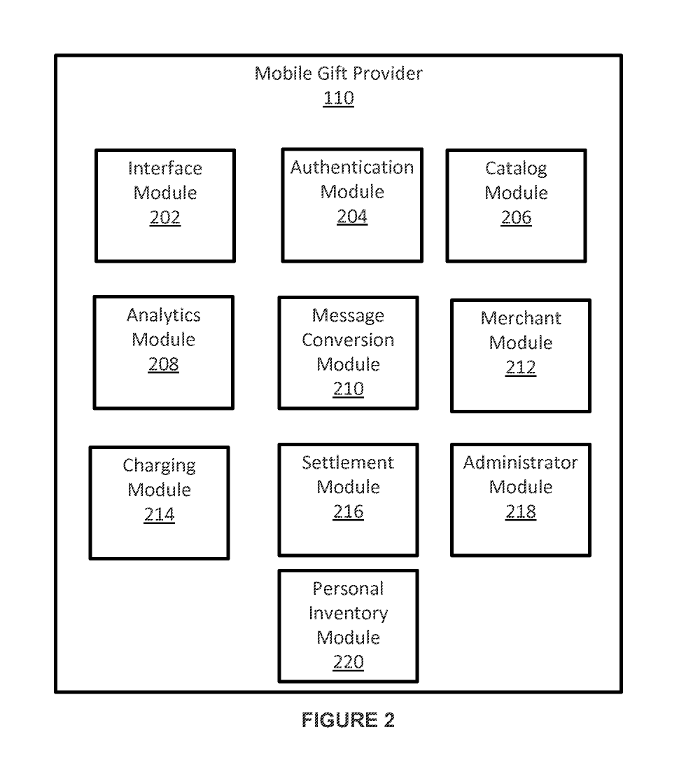

Gift provider system 110 may include one or more devices, modules, and/or components for providing routing information for transmitting data over a network, such as, for example, an IP network and/or a PSTN. For example, gift provider system 110 may be part of, or communicatively coupled to, network 108, and may receive a request from a user device to purchase a gift and send the gift to another user device via a messaging service. Gift provider system 110 may include an interface module, an authentication module, a catalog module, an analytics module, a message conversion module, a merchant module, a charging module, a settlement module, and an administrator module as described herein in reference to FIG. 2. In other embodiments, gift provider system 110 may be implemented as an application on user device 102. Gift provider system 110 may comprise one or more network enabled computers. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device.

FIG. 2 is a block diagram of a hardware component of an exemplary embodiment of gift provider system 110. For example, gift provider system 110 may include an interface module 202, an authentication module 204, a catalog module 206, an analytics module 208, a message conversion module 210, a merchant module 212, a charging module 214, a settlement module 216, an administrator module 218, and a personal inventory module 220. It is noted that modules 202, 204, 206, 208, 210, 212, 214, 216, 218, and 220 are exemplary and the functions performed by one or more of the modules may be combined with that performed by other modules. The functions described herein as being performed by modules 202, 204, 206, 208, 210, 212, 214, 216, 218, and 220 may also be separated and may be performed by other modules at devices local or remote to gift provider system 110. The modules may each be a computer program or an appropriately programmed computer, such as a mainframe or personal computer, or may include a plurality of such computers cooperating to perform the functionality described herein. Modules 202, 204, 206, 208, 210, 212, 214, 216, 218, and 220 may also communicate with data storage 120. Modules 202, 204, 206, 208, 210, 212, 214, 216, 218, and 220 may also be coupled to or integrated with gift provider system 110. For example, modules 202, 204, 206, 208, 210, 212, 214, 216, 218, and 220 may be external devices that are wirelessly coupled and/or communicatively coupled to gift provider system 110 via an interface port which may include, without limitation, USB ports, system bus ports, or Firewire ports and other interface ports. Further, computer code may be installed on gift provider system 110 to control and/or operate a function of interface module 202, authentication module 204, catalog module 206, analytics module 208, message conversion module 210, merchant module 212, charging module 214, settlement module 216, administrator module 218, and/or personal inventory module 220.

Interface module 202 may be configured to interface with user device 102 and/or user device 106. Interface module 202 may represent a network connection between a user device and gift provider system 110. Interface module 202 may receive data from user device 102 and provide data to user device 102. The user of user device 102 may interact with interface module 202 using manual input (e.g., typing into a keyboard or keypad, etc.), voice input, touch screen input, graphical input (e.g., camera or camcorder) and/or any other method for inputting information or data to user device 102. Interface module 202 may provide a series of interactive screens for display for user device 102. User devices 102 and/or 106 may access interface module 202 via messaging application 104.

Interface module 202 may receive a request for a gift catalog display from user device 102. User device 102 may transmit the request via network 108 in response to the user's selection of one or more options in messaging application 104. As shown in the embodiment of FIG. 3A, messaging interface 302 includes a “gift” option 306. Messaging interface 302 may always include gift option 306. In various embodiments, messaging interface 302 may include gift option 306 based on whether the user has previously received a gift message. Messaging interface 302 may include gift option 306 based on the current date and/or time maintained in device 102. For example, if the current date is near a holiday (such as Christmas), messaging interface 302 may include gift option 306. Messaging interface 302 may have access to a calendar stored on user device 102 and/or a contact list. The calendar and/or contact list may include birthdays, anniversaries, graduations, and other events associated with the calendar and/or contact list. Messaging interface 302 may determine that the current date corresponds to a birthday of an individual in the contact list or calendar (or within a predetermined number of days prior to the birthday), and messaging interface 302 may display gift option 306 accordingly. In one or more of the above embodiments, the gift option 306 may only appear if the predetermined condition(s) is met. The user of user device 102 may be sending and receiving messages from the user of user device 106. This conversation may be shown on messaging interface 302 of user device 102. The conversation may include messages between user device 102 and user device 106, sent via network 108. In various embodiments, the conversation may be a group conversation (e.g., including more than two participants). If the user of user device 102 desires to send a “gift message,” he may select the “gift” option 306 on messaging interface 302. In response, user device 102 may transmit a gift catalog request to gift provider system 110, which may be received by interface module 202.

Authentication module 204 may be configured to authenticate the user of user device 102 in response to the received gift catalog request. This authentication process may be separate from other authentication steps necessary for the user to access network 108 or other services using device 102. The user may have a profile with gift provider system 110. The user's profile information may be stored in data storage 120. The profile may include a username and/or password. The profile may include information associated with the user (e.g., age, occupation, gender, relationship status, employment status, educational background, physical address, email addresses, phone numbers, etc.). The profile may be linked to the user's various social media accounts (e.g., Facebook profile, Instagram, Linkedin, etc.). The profile may include payment information for the user (e.g., bank account numbers, checking account number, routing number, credit card numbers, etc.). Interface module 202 may present a screen requiring the user to enter his or her username and password. Authentication module 204 may compare the received username and password to those stored in data storage 120. If the user already has a profile and authentication module 204 finds a matching username and password, the user may be allowed to continue as described below. If authentication module 204 does not find a match for the username and password, the user may be given the option of creating a new profile and/or resetting their password.

In various embodiments, authentication module 204 may be linked to other authentication features associated with device 102. For example, device 102 may have an initial login screen that requires the user to enter a password and/or biometric data in order to access the features of user device 102. If the user enters the correct password and/or biometric data (e.g., a fingerprint, a retinal scan), user device 102 may grant the user access to the device features. Authentication module 204 may then automatically authenticate the user.

If the user is authenticated by authentication module 204, catalog module 206 may generate one or more interfaces that are configured to allow the user of user device 102 to browse, select, and/or purchase one or more gifts for sending to user device 106 as a gift message. Catalog module 206 may receive the gift options request from interface module 202. The request may include authentication information for the user of user device 102 (in this example, the user's name is Joe Hinson). The request may include information associated with the recipient (in this example, the recipient's name is Bob Hinson). The information may include a phone number and/or email address associated with the recipient.

Gifts may be provided by merchants, such as merchant 112. Gifts may be electronic gift cards associated with a merchant, such as merchant 112. A gift may include a gift value that can be redeemed with the issuing merchant. The gift may include the name of the merchant or merchants associated with the gift. The gift may include artwork or graphics, as will be discussed in reference to FIGS. 3D and 3E. Administrator module 218 manages the inventory of gifts available to catalog module 206. Administrator module 218 may store information related to gifts and merchants in data storage 120. Administrator module 218 may receive gift information from one or more merchants, such as merchant 112. The gift information may include a percentage of the gift purchase price that is received by gift provider system 110 when a user purchases the gift. Gift provider system 110 may be associated with a service provider (not shown).

FIGS. 3B-3D show example embodiments of one or more catalog interfaces generated by catalog module 206 on user device 102. FIG. 3B shows an example catalog interface showing one or more merchant icons 308a-308x. Each icon may be display a logo, trademark, name, or other information identifying a specific merchant offering one or more gifts for purchase by the user of user device 102. The catalog interface may include a selection feature 310. Catalog module 206 may assign each of the one or more merchant icons may be to one or more categories 312a-x. If the user of user device 102 selects category option 310, he may be presented with a drop-down menu showing the one or more categories 312a-x. If a user selects one or more of the categories 312a-x, category module 206 may provide merchant icons assigned to those categories for display on the catalog interface. For example, if the user selects the “shopping category,” then category module 206 may only display icons associated with Amazon, Bed Bath & Beyond, Nordstrom, Best Buy, Barnes & Noble, and Target (assuming catalog module 206 had previously assigned those merchants to the shopping category). Administrator module 218 may determine which merchant icons are associated with which categories. Exemplary embodiments of systems and methods of associating categories and subcategories with different merchants and products are described in U.S. patent application Ser. No. 14/269,665, filed on May 5, 2014, which is incorporated by reference in its entirety. Note that although the catalog interface in FIG. 3B only displays 12 merchant icons, the user may be able to view additional icons by scrolling down, left, right, up, and/or by other options on the screen of user device 102.

Catalog module 206 may manage how different merchant icons are presented to the user of user device 102 on the catalog interface. Catalog module may display merchants and/or gifts to a user based on the percentage received by gift provider system 110. For example, if gift provider system 110 receives 5% of the sale price of each gift message that a user purchases from Merchant A, but only 4% of each gift message that a user purchases from Merchant B, then catalog module 206 may display gift offerings from merchant A more prominently to the user of user device 102 than those of merchant B. For example, the icon associated with merchant A may be larger than other icons. The icon may be highlighted to draw the user's attention to it. The icon may be placed in the top row of the icons 308a to 308x.

Analytics module 208 may collect statistics from users who purchase gift messages and analyze them to determine what types of gifts and/or merchant icons catalog module 206 will present to the user of user device 102. Analytics module 208 may track which users purchase which gifts from which merchants and/or for which recipients. Analytics module 208 may maintain records of the types of gifts purchased by other users. Analytics module 208 may maintain records of past gifts purchased by the user of user device 102. Analytics module 208 may associate demographic information from other users with different gifts and/or different merchants. Demographic information may include, without limitation, gender, occupation, age, location, ethnicity, relationship status, and social networking information of different users. For example, analytics module 208 may determine that male users between the ages of 25 and 40 are more likely to purchase gift cards from Best Buy than other users, based on past purchases by users within that demographic. If the user of user device 102 is a 35 year-old male, analytics module 208 may generate one or more gift recommendations for catalog module 206 to present a catalog interface that includes merchant icons from electronics merchants (such as Best Buy) for user device 102. If the user has a history of purchasing restaurant related gift cards, analytics module 208 may generate one or more gift recommendations for catalog module 206 to present a catalog interface that includes merchant icons from restaurant and/or fast-food merchants for user device 102.

If the user of user device 102 selects a specific merchant icon (from icons 308a to 308x), catalog module 206 may provide one or more interfaces for specific gift offerings from that merchant. FIG. 3C depicts an embodiment of a gift offering from a specific merchant, as shown on the screen of user device 102. Catalog module 206 may provide an interface wherein the user can personalize the gift, select the amount of the gift, select artwork and/or graphics to be included in the gift, create a personalized message, and/or pay for the gift. In this example, the user of user device 102 (Joe Hinson) is seeking to buy a gift for his brother (Bob Hinson). Catalog module 206 may have received information associated with Joe Hinson and Bob Hinson from interface module 202 when interface module 202 first received the gift request. The information may include a phone number and/or email address associated with user device 106.

In various embodiments, the layout provided by catalog module 206 may vary depending on the user profile. For example, if the user previously bought a gift from a certain merchant, that merchant icon may be highlighted in the layout and/or displayed near the top of the layout. If the user previously bought a gift for the intended gift recipient, the merchant icon associated with that gift may be highlighted and/or displayed near the top of the layout. If the user regularly buys gifts from within a certain category, that category may be displayed first in the list of categories.

As shown in FIG. 3C, the user of user device 102 may be able to select the value 314 of the gift. In this embodiment, the user has three options ($5, $10, and $25). Other embodiments may include more options and may include an interactive box where the user can enter a custom amount for the gift. The value 314 selected by the user will correspond to the purchase price. The user may be able to include a personalized message with the gift by selecting option 322. If the user selects option 322, a box may appear allowing the user to enter type or speak a short message for the recipient. The message 322 is then able to be included in the gift message.

The user may be able to select artwork 316 to accompany the gift. The artwork may be one or more images and/or other graphics that are created by the merchant and/or a third party and associated with the gifts offered by that merchant in data storage 120. The artwork may be displayed as a “postcard” as part of the gift message. If the user does not like the artwork 316 offered, he may be able to select other artwork using option 320.

If the user selects option 320, catalog module 206 may present one or more interfaces such as the interface shown in FIG. 3D. In this interface, catalog module 206 may display other artwork options 326a-x. The artwork may be divided into one or more categories (e.g., Shapes, Textures, Landscapes, People, Space, Oceans, etc.). Catalog module 206 may allow the user to scroll through different artwork and select the artwork the user wants to include with the gift. In various embodiments, the user may be able to select and combine multiple segments of artwork in one gift message. In various embodiments, the user may be able to upload custom artwork from device 102 to include with the gift message. The user may have access to artwork uploaded by other users.

In various embodiments, the artwork 326a to 326x may depend on the merchant. The artwork may depend on the user (the gift buyer). The artwork may depend on artwork the gift buyer has bought in the past. The artwork may depend on the gift recipient (for example, if the Joe Hinson has previously included artwork from the “Landscapes” category in gift messages sent to Bob Hinson, this artwork may be prominently displayed for Joe when he purchases a new gift message for Bob). The artwork may be seasonal and may depend on the current date and time. The artwork may include themes related to upcoming holidays. For example, if the current date is within a certain date range from December 25, the artwork may be Holiday-themed. If the current date is within a certain date range of July 4, the artwork may have a patriotic theme.

Once a user has selected artwork to be included with the gift message, the user may select a method of payment, shown as payment option 324 in FIG. 3C. The user may have one or more payment accounts associated with his profile. The user may select a payment account that will be charged for the cost of the gift. In this example, once the user (Joe Hinson) purchases the gift for Bob Hinson, his payment account will be charged $5. FIG. 3E depicts an embodiment of a screen provided by catalog module 206 when the user selects the purchase option 318 and is ready to have the gift message sent to the recipient user device 106. Confirmation box 328 may be displayed, summarizing the gift being purchased by the user of user device 102 (including the merchant, the gift amount, the name of the recipient, and other relevant information). The user may confirm the purchase, or cancel and go back to a previous display. In various embodiments, the user may input the name of the recipient and contact associated with the recipient's user device (e.g., a phone number and/or email address).

Message module 210 may generate a gift message in response to the user confirming the purchase. Message module 210 and/or interface module 202 may transmit the gift message to the recipient (user device 106). Message module 210 may send the gift message as an MMS message. Message module 210 may send the gift message over network 108. Embodiments of the gift message are shown in FIGS. 3F, 4A, 4B, 4D, and 4E.

FIG. 3F shows an embodiment of the messaging interface 302 of user device 102 after the user has purchased the gift and the gift message has been transmitted to user device 106. In this example, messaging interface 302 shows messages exchanged between Joe Hinson (user device 102) and Bob Hinson (user device 106). The gift message 328 shown in interface 302 includes the amount of the gift, the name of the recipient (Bob Hinson), and may include the name of the merchant and other interactive features, allowing the user of user device 102 to see other features of the gift message.

FIG. 4A shows an embodiment of cover 406 of the gift message on user device 106 (the recipient's device). In this embodiment, user device 106 may have a messaging interface 402 (similar to messaging interface 302 on user device 102). The messaging interface 402 may be provided by messaging application 104. The messaging interface 402 may include the name of the sending party (Joe Hinson) in the top left hand corner. The user of device 106 may be able to scroll up in messaging interface 402 to view earlier messages from the other party (Joe Hinson). The messaging interface 402 may include a text entry box 404 (similar to text entry box 304 on user device 102). The cover 406 may inform the recipient that he has received a gift. The cover may have one or more interactive features. If the recipient selects a feature of the cover 406, the gift message may be displayed.

FIG. 4B shows an embodiment of a gift message 408 received on user device 106. The gift message 408 may be displayed on messaging interface 402. The gift message may include the artwork 410 (previously selected by the user of user device 102). The artwork may be a postcard within the gift message. The artwork 410 may include digital images and/or video elements. The gift message 408 may include the name of the sender (Joe Hinson). The gift message 408 may include the amount of the gift ($5.00), the name of the merchant, one or more codes 412a and 412b, the personalized message 414b from the sender, and/or one or more interactive features 414a where the recipient can download a software application associated with the merchant. The codes 412a and 412b may be generated by message module 210. The personalized message 414b may be based on the personalized message 322 created by the user of user device 102.

Merchant module 212 may be configured to send and receive data to and from one or more merchants (such as merchant 112) for gifts associated with those merchants. Merchant module 212 may comprise an application programming interface (API) and may interact with one or more other modules in gift provider system 110. When a user purchases a gift message for a recipient (using the process described above), merchant module 212 may interact with the merchant associated with the purchased gift message. Merchant module 212 may receive code data (used by message module 210 to create the one or more codes 412a and 412b). Code 412a may be a bar code. Code 412a may be a QR code. Code 412b may be a serial number, PIN number, redemption code, or other string of characters that are maintained by the merchant associated with the gift card and associated with the gift message.

Merchant module 212 may provide the code data to message module 210, which may use the code data to generate the codes (such as 412a and/or 412b) for the gift message. Merchant module 212 may receive other unique information associated with the gift purchased by the user and provide that information to message module 210 to create the gift message. Merchant module 212 may provide one or more hyperlinks to message module 210, which are linked to websites associated with the merchant. Message module 210 may include the hyperlinks in the gift message. Merchant module 212 may provide links to software applications that can be downloaded by the recipient for their user device. Message module 210 may include these links in the gift message (e.g., link 414a).

The user of user device 106 may redeem the gift message online by, for example, entering the code 412b at a web portal hosted by the merchant associated with the gift message. The user of user device 106 may redeem the gift message using an application on user device 106 (e.g., by downloading a merchant-specific application using feature 414a on the gift message). The user of user device 106 may physically redeem the gift message at a store operated by the merchant by providing code 412a to a bar code scanner and/or QR scanner at the merchant's location. The gift message may be redeemed at a physical location based on the user physically entering code 412b at a kiosk at the merchant's location. Once the user takes the necessary steps to redeem the gift message, he will be allowed by the merchant to purchase goods and services up to and including the value of the gift message (or combine the value of the gift message with other methods of payment and/or other gift cards and gift messages).

Messaging module 210 and/or merchant module 212 may include one or more interactive maps in the gift message showing merchant locations nearby the user of user device 106 where the gift message can be redeemed. Messaging module 210 may use location information received from user device 106 to generate the map.

Charging module 214 may charge an account associated with the user of user device 102 for the amount of the gift. The user of user device 102 may select option 324 in FIG. 3C to select a specific account to be used as the source of payment for the gift. When the user of user device 102 completes the purchase of the gift, charging module 214 may debit the user's selected account for the price of the gift. Settlement module 216 may be configured to interact with merchants, such as merchant 112, to ensure they are compensated for gift messages that are purchased by users. Administrator module 218 may add and remove merchants and manage the inventory of gift messages available for purchase.

Data storage 120 may maintain an inventory of gift messages purchased for a user, such as the user of user device 106. Each time a gift message is purchased for that user, data storage 120 may update the inventory associated with that user to include a record of the most recent gift message. FIG. 4C shows an embodiment of a screenshot of an interface provided by interface module 202 where the user of user device 106 can view the inventory of the gift messages he has received. The user of user device 106 may access this inventory from messaging interface 402. As shown in FIG. 4C, the user may select “Gift Cards” 418 to view the inventory of gift messages. In example, the user of user device 106 (Bob Hinson) has received three gift messages.

FIG. 4D shows an embodiment of a screenshot of an interface of the gift inventory presented to the user of user device 106 by personal inventory module 220. Personal inventory module 220 may retrieve the inventory information for the user of user device 106 from data storage 120 and provide it in an interface. The inventory includes the three gift messages received by that user—420a, 420b, and 420c. The user may be able to scroll through the inventory and select individual gift messages. The inventory may include the remaining balance for each specific gift message. The inventory may list the merchant or merchants corresponding to the gift message. The inventory may display the artwork associated with each gift message. The inventory may include the name of the individual who purchased the gift message for that user. The user of user device 106 may be able to sort the inventory to only display gift messages for certain merchants, or only display gift messages that have not been redeemed, or only display gift messages from certain individuals. Each gift message may include one or more interactive features, such as feature 422, which allows the user to send the gift message to a friend, mark as redeemed, or remove the gift message from the inventory.

FIG. 4E shows an embodiment of an inventory display of gift message 420c received on user device 106. The gift message 420c may be provided by personal inventory module 220. The gift message may be displayed in response to the user selecting gift message 420c from the inventory shown in FIG. 4D. The gift message 420c may include the same features as the gift message 408 shown in FIG. 4B. Gift message 420c may show the remaining balance for the gift message. When the gift recipient redeems part of the gift with a merchant, the balance associated with the gift is updated by merchant module 212 to reflect the remaining balance on the gift message. Gift message 420c may include interactive feature 424 allowing the user to copy a PIN associated with the gift message and/or copy code 412b. The user of user device 106 may access gift message 420c using the inventory in order to redeem some or all of the balance on gift message 420c with the corresponding merchant.

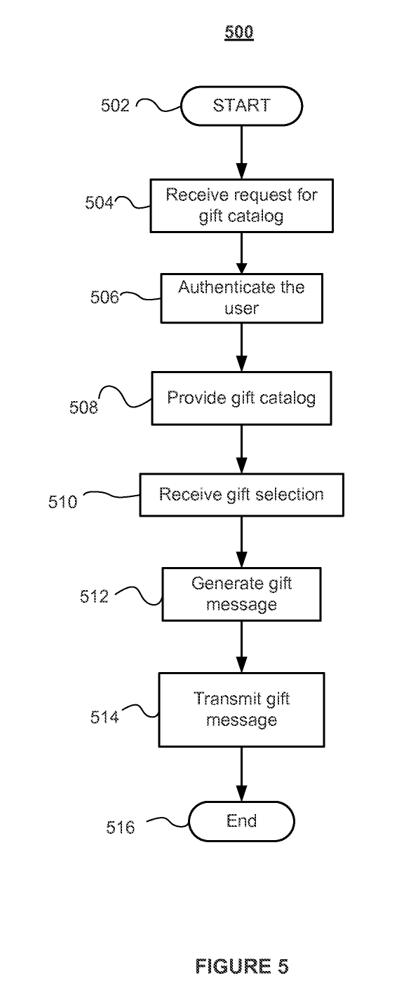

FIG. 5 is a flowchart illustrating the functionality of a method according to an embodiment of the disclosure. This method is provided by way of example, as there are a variety of ways to carry out the methods described herein. Method 500 shown in FIG. 5 may be executed or otherwise performed by one or a combination of various systems. The method 500 may be carried out through system 100 of FIG. 1 and/or the one or more modules shown in FIG. 2, by way of example, and various elements of FIG. 1 and FIG. 2 are referenced in explaining method 500 of FIG. 5. Each block shown in FIG. 5 represents one or more processes, methods, or subroutines carried out in method 500. Method 500 may begin at block 502.

At block 504, method 500 may receive a request for a gift catalog from a user device. The request may include the name and contact information of the recipient. The request may be received by a gift provider system. At block 506, method 500 may authenticate the user. The user may be prompted to provide authentication information (e.g., a username and/or a password). The profile may include a username and/or password. The profile may include information associated with the user (e.g., age, occupation, gender, relationship status, employment status, educational background, physical address, email addresses, phone numbers, etc.). The profile may be linked to the user's various social media accounts (e.g., Facebook profile, Instagram, Linkedin, etc.). The profile may include payment information for the user (e.g., bank account numbers, checking account number, routing number, credit card numbers, etc.). The gift provider system may maintain a database of user profiles and compare the authentication information to information associated with each user profile. If there is a match, the user may be authenticated and method 500 may proceed to block 508.

At block 508, method 500 may provide a gift catalog to the user device. The catalog may comprise one or more merchant icons, wherein each merchant icon is associated with gift cards for purchase from that merchant. The user may browse, select, and/or purchase one or more gifts for sending to another user device as a gift message. The merchant icons and/or gifts displayed to the user in the gift catalog may be based on the user's profile. The merchant icons and/or gifts displayed to the user in the gift catalog may be based on past gifts purchased by the user. The merchant icons and/or gifts displayed to the user may be based on gifts purchased by other users in a similar demographic. The merchant icons and/or gifts displayed to the user in the gift catalog may be based on a sales percentage received by the gift provider system for each gift.

At block 510, method 500 may receive a gift selection. A gift may be selected from the gift catalog by the user of the user device. Gifts may be electronic gift cards associated with one or more merchants. The user may select the value of the gift. The gift may include the name of the merchant or merchants associated with the gift. The user may be able to select artwork to be included with the gift. The artwork may be one or more images and/or other graphics that are created by the merchant, the user, other users, and/or a third party. The artwork may be displayed as a “postcard” as part of the gift message. The user may include a personalized message in the gift. The user may specify who the recipient of the gift should be by including the recipient's name, and a phone number and/or email address associated with the recipient's device. The user may select the method of payment for the gift.

At block 512, method 500 may generate a gift message based on the gift selected by the user. The gift message may be an MMS message. The gift message may include the name and/or logo of the merchant. The gift message may include the name of the recipient. The gift message may include the value of the gift. The gift message may include one or more interactive features that link to software applications for the recipient's device. The gift message may include one or more codes that can be used to redeem the gift with the merchant. The codes may include bar codes, QR codes, redemption codes, serial numbers, PIN numbers, and other strings of characters that the merchant may associate with the gift message.

At block 514, method 500 may transmit the gift message to the recipient's device. The gift message may be sent as an MMS message. The recipient may receive the gift message on his device. The recipient may redeem the gift message with the merchant using the one or more codes in exchange for goods or services from the merchant. At block 516, method 500 may end.

The various computing devices above (including phones and network equipment), generally include computer-executable instructions, where the instructions may be executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

Databases, data repositories or other data stores described herein, such as the data storage 120, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a processor; and
a memory comprising computer-readable instructions which when executed by the processor cause the processor to:
receive a request for a gift catalog from a first communications device;
provide a gift catalog to the first communications device based at least in part on profile information associated with the first communications device;
receive a selection of a gift card from the first communications device, wherein the gift card is selected from the gift catalog, wherein the gift card is associated with one or more merchants;
generate a multimedia messaging service message based on the gift card; and
transmit the multimedia messaging service message to a second communications device.

2. The system of claim 1, wherein the multimedia messaging service message comprises at least one of a gift value, a merchant identifier, a gift code, a graphic, a link, a personalized message, a sender name, and a recipient name.

3. The system of claim 2, wherein the gift code is associated with the one or more merchants associated with the gift card, wherein the gift code comprises at least one of a bar code, a QR code, a serial number, a PIN, and a redemption code.

4. The system of claim 2, wherein at least one of the gift value, the graphic, the recipient's name, and the personalized message are selected by a user of the first communications device

5. The system of claim 3, wherein the gift card can be redeemed with the one or more merchants using the multimedia messaging service message on the second communications device.

6. The system of claim 2, wherein the merchant identifier is associated with the one or more merchants associated with the gift card.

7. The system of claim 1, wherein the gift catalog comprises a plurality of gift cards, wherein the plurality of gift cards are based on at least one of past purchases by a user associated with the first communications device, profile information associated with the user, past purchases by a plurality of other users, and demographic information associated with the plurality of other users.

8. The system of claim 7, wherein the plurality of gift cards are based on one or more similarities between the demographic information associated with the plurality of other users and the profile information associated with the user.

9. The system of claim 1, wherein the request for a gift catalog is sent from the first communications device using an interface that includes messages exchanged between the first communications device and the second communications device.

10. The system of claim 1, wherein the memory comprises additional computer-readable instructions which when executed by the processor cause the processor to:
receive a request for a gift card inventory from the second communications device; and
provide a gift card inventory catalog to the second communications device, wherein the gift card inventory catalog comprises information associated with one or more multimedia messaging service messages that have been received by the second communications device.

11. A method, comprising:
receiving a request for a gift catalog from a first communications device;
providing a gift catalog to the first communications device based at least in part on profile information associated with the first communications device;
receiving a selection of a gift card from the first communications device, wherein the gift card is selected from the gift catalog, wherein the gift card is associated with one or more merchants;
generating a multimedia messaging service message based on the gift card; and
transmitting the multimedia messaging service message to a second communications device.

12. The method of claim 11, wherein the multimedia messaging service message comprises at least one of a gift value, a merchant identifier, a gift code, a graphic, a link, a personalized message, a sender name, and a recipient name.

13. The method of claim 12, wherein the gift code is associated with the one or more merchants associated with the gift card, wherein the gift code comprises at least one of a bar code, a QR code, a serial number, a PIN, and a redemption code.

14. The method of claim 12, wherein receiving a selection of a gift card from the first communications device comprises receiving a selection of at least one of the gift value, the graphic, the recipient's name, and the personalized message.

15. The method of claim 13, wherein the gift card can be redeemed with the one or more merchants using the multimedia messaging service message on the second communications device.

16. The method of claim 12, wherein the merchant identifier is associated with the one or more merchants associated with the gift card.

17. The method of claim 11, wherein the gift catalog comprises a plurality of gift cards, wherein the plurality of gift cards are based on at least one of past purchases by a user associated with the first communications device, profile information associated with the user, past purchases by a plurality of other users, and demographic information associated with the plurality of other users.

18. The method of claim 17, wherein the plurality of gift cards are based on one or more similarities between the demographic information associated with the plurality of other users and the profile information associated with the user.

19. The method of claim 11, wherein the request for a gift catalog is sent from the first communications device using an interface that includes messages exchanged between the first communications device and the second communications device.

20. The method of claim 11, further comprising:
receiving a request for a gift card inventory from the second communications device; and
providing a gift card inventory catalog to the second communications device, wherein the gift card inventory catalog comprises information associated with one or more multimedia messaging service messages that have been received by the second communications device.
